(19) United States
(12) Patent Application Publication
(10) Pub. No.: US 2024/0110434 A1
(43) Pub. Date: Apr. 4, 2024

(54) SPACER FOR INSULATING GLAZINGS

(71) Applicant: SAINT-GOBAIN GLASS FRANCE, COURBEVOIE (FR)

(72) Inventors: Marie GUIN, AACHEN (DE); Nikolai BORCHMANN, HERZOGENRATH (DE); Walter SCHREIBER, AACHEN (DE)

(21) Appl. No.: 18/264,673

(22) PCT Filed: May 19, 2022
(86) PCT No.: PCT/EP2022/063626

§ 371 Date: Aug. 8, 2023

(30) Foreign Application Priority Data
May 25, 2021 (EP) 21175568.1

(51) Int. Cl. E06B 3/663

(52) U.S. Cl. CPC E06B 3/66333; E06B 3/66352; E06B 3/66361

(57) ABSTRACT

A spacer for insulating glazings, includes a U-shaped polymeric base body extending in the longitudinal direction including a first leg having a first pane contact surface, a second leg having a second pane contact surface and an outer surface, via which the first pane contact surface and the second pane contact surface are connected to one another, a polymeric cover plate extending in the transverse direction parallel to the outer surface between the first pane contact surface and the second pane contact surface, wherein the cover plate encloses a hollow chamber with the U-shaped polymeric base body, the polymeric cover plate is connected to the first leg and the second leg of the U-shaped polymeric base body in each case via a positive pin connection.

The invention relates to a spacer for insulating glazings, an insulating glazing comprising such a spacer, and a method for the production thereof.

It is nowadays impossible to imagine building construction without insulating glazings, especially in the wake of increasingly stringent environmental protection requirements. These glazings are manufactured from at least two panes, which are connected to one another via at least one peripheral spacer. Depending on the embodiment, the intermediate space of the two panes, referred to as the glazing interior, is filled with air or gas, but in any case is free of moisture. An excessively high content of moisture in the glazing intermediate space, in particular in the case of cold external temperatures, leads to condensation of water droplets in the pane intermediate space, which absolutely has to be avoided. Hollow body spacers filled with a desiccant, for example, can be used to absorb the residual moisture remaining in the system after assembly.

In addition to sealing the space between the panes against moisture, another crucial task of the spacer is the thermal decoupling of the building interior on one side of the insulating glazing and the environment on the opposite side of the insulating glazing. The thermal conductivity of the spacers has a non-negligible influence on the thermal properties of the pane. Spacers consist of a light metal, usually aluminum, in one of the known embodiments. These can be processed easily, but the insulating effect of the glazing in the edge region is significantly reduced due to the good thermal conductivity of the aluminum (also known as the cold edge effect).

To improve the thermal properties, so-called warm edge solutions for spacers are known. These spacers are made in particular of plastic and consequently have a significantly reduced thermal conductivity. Depending on the choice of plastic, plastic spacers lack sufficient gas tightness, which in turn can be achieved by insulating films applied to the outer surface of the spacers.

WO 2013/104507 A1 discloses a spacer with a polymeric hollow profile base body and an insulating film. In this case, the insulating film contains a polymeric film and at least two metallic or ceramic layers which are arranged in alternating fashion with at least one polymer layer.

From CN 211473861 U and WO 2020 053082 A1, hybrid spacers are known that are composed of metallic and polymeric components. Furthermore, polymeric spacers are also known into which metallic reinforcing elements are introduced. For example, DE 10 2015122714 A1 describes a polymeric spacer, the material of which is foamed at least in partial regions and which has a stainless steel foil as a reinforcing element. EP 2668361 B1 describes a polymeric spacer with a first plastic material and a second plastic material, wherein the second plastic material is present in the region of the outer wall and comprises a layer silicate. Such spacers with multiple components that are irreversibly connected to one another are difficult to dismantle and recycle into their individual components after the end of the service life of the glazing.

In DE 202015105147 U1, a polymeric spacer for insulating glazings is disclosed which is composed of two or more spacer parts connected to one another with a material, positive, and/or non-positive fit.

CN 211473861 U discloses a spacer for insulating glazings which comprises a U-shaped profile and a cover plate, wherein the cover plate is positively connected to the U-shaped profile via a sawtooth snap-on connection.

In the context of a production that protects resources, it is desirable to return products back into the material cycle after the end of their service life. As the recycling rate increases, this also applies more and more to long-lasting and more complex products, such as insulating glazings. Also with regard to the spacers themselves, there is a need to be able to disassemble them into their individual components, wherein any desiccant and any barrier film that may be present should also be easy to separate.

It is accordingly an object of the present invention to provide a spacer having a low thermal conductivity and good recyclability, an insulating glazing having this spacer, and a method for producing the spacer.

The object of the present invention is achieved according to the invention by a spacer and an insulating glazing with a spacer according to the independent claims 1 and 15. Preferred embodiments of the invention result from the subclaims.

The spacer according to the invention for insulating glazings comprises at least one U-shaped polymeric base body extending in the longitudinal direction (X direction) and a polymeric cover plate. The polymeric cover plate is here arranged on the open edge of the U-shaped polymeric base body, wherein cover plate and U-shaped polymer base body enclose a hollow chamber with one another. The U-shaped polymeric base body comprises at least one first leg with a first pane contact surface, a second leg with a second pane contact surface, and an outer surface. The outer leg surfaces of the U-shaped polymeric base body facing away from one another are referred to as pane contact surfaces. The outer surface of the base of the U-shaped polymeric base body is referred to as the outer surface. The polymeric cover plate extends in the transverse direction (Y direction) parallel to the outer surface between the first pane contact surface and the second pane contact surface. The polymeric cover plate here forms the glazing interior surface of the spacer. The glazing interior surface refers to the surface of the spacer which, in the installed state of the spacer in an insulating glazing, faces the glazing interior. The polymeric cover plate is connected to the first leg and the second leg of the U-shaped polymeric base body in each case via a positive pin connection. The positive pin connection enables a secure connection of the polymeric cover and of the U-shaped polymeric base body, wherein an accidental release of the connection is avoided by the positive fit. A positive connection here also provides greater stability during pressing of the spacer with the panes of an insulating glazing. Here as well the positive connection ensures that the cover plate is not released by the pressure applied laterally to the pane contact surfaces of the spacer. At the same time, the positive pin connection is a reversible connection of the polymeric cover plate to the U-shaped base body. The cover plate and the base body can be separated from one another by moving the two components relative to one another. After the end of the service life of an insulating glazing having a spacer according to the invention, the spacer can be opened by removing the cover plate. In this way, a desiccant that may be located in the hollow chamber of the spacer can be removed and sent to separate disposal. The simple separability of the base body and the cover plate also facilitates the use of different materials for the base body and the cover plate, while maintaining good recyclability. Thus, for example, the U-shaped polymeric base body can be manufactured from a recycling material, while the cover plate visible in the glazing interior of the insulating glazing is made of another material, independently of the material of the base body. A visually appealing surface finish and, if necessary, the coloring desired by the customer here only have to be ensured with regard to the cover plate. The base body, which is not visible in the insulating glazing when installed, can be made from a recycled material that may be visually inhomogeneous.

The spacer according to the invention is thus easily recyclable after the end of the service life of the glazing, and thus contributes to insulating glass products that save resources. Furthermore, the design of the spacer according to the invention also simplifies the use of recycling materials for producing the spacer. Furthermore, the spacer has an advantageously low thermal conductivity compared to metallic spacers or spacers with metallic components.

The two pane contact surfaces of the spacer are designated first pane contact surface and second pane contact surface. The first pane contact surface and the second pane contact surface represent the sides of the spacer on which the mounting of the outer panes (first pane and second pane) of an insulating glazing takes place when the spacer is installed. The first pane contact surface and the second pane contact surface lie opposite one another and run parallel to one another. The first pane contact surface and the second pane contact surface are connected to one another via the outer surface. The cover plate connects the first leg and the second leg of the base body to one another, wherein the surface of the cover plate, via which the pane contact surfaces are connected to one another, is referred to as the glazing interior surface. The glazing interior surface is the surface of the spacer which, in the installed state, faces the glazing interior of the insulating glazing. The space enclosed by the pane contact surfaces, the outer surface and the glazing interior surface is the hollow chamber of the spacer. The hollow chamber extends along the base body, i.e., is designed as a hollow profile spacer. The glazing interior surface and the exterior surface run parallel to each other at least in sections.

The glazing interior surface is defined as the surface of the spacer base body that, after installation of the spacer in an insulating glazing, faces in the direction of the interior of the glazing. The glazing interior surface is located between the first and the second pane.

The outer surface of the spacer base body is the side opposite the glazing interior surface, which faces away from the interior of the insulating glazing in the direction of an outer seal. The glazing interior surface and the outer surface extend, with the exception of the angled sections, preferably substantially parallel to one another.

The first pane contact surface and the second pane contact surface represent the surfaces of the spacer that are used for mounting the panes of an insulating glazing. The first pane contact surface and the second pane contact surface are substantially parallel to one another.

The hollow chamber of the spacer is adjacent to the glazing interior surface, wherein the glazing interior surface is located above the hollow chamber and the outer surface of the spacer is located below the hollow chamber. In this context, above is defined as facing the inner pane space of the insulating glazing in the installed state of the spacer and below is defined as facing away from the inner pane space.

The hollow chamber of the spacer results in a weight reduction compared to a solidly molded spacer and is available for accommodating other components, such as a desiccant.

The positive pin connection of the spacer according to the invention comprises at least one pin and at least one slot, wherein the pin engages in the slot and the two together form the positive pin connection. The cover plate and the u-shaped base body are reversibly connected to one another via the pin connection. The cover plate and u-shaped base body can, for example, be separated from one another by inserting the pin of the one component into the slot of the other component via an open cross-section.

In a preferred embodiment of the spacer according to the invention, the at least one positive pin connection has an undercut. The undercut is preferably designed such that the diameter of the pin is variable. In at least one first section of the pin, the pin diameter here is smaller than the pin diameter than in at least one second section, wherein the distance between the first section and the planar contact surface of the components to be connected is smaller than the distance between the second section and the planar contact surface of the components to be connected. The planar contact surface of the components to be connected is defined here as the surface on which the components adjoin one another outside the pin connection. The planar contact surface can also be determined by leaving the pin connection out of consideration and regarding the boundary surface of the components lying planarly next to one another. The undercut of the pin connection is formed in that a first section of the pin, lying closer to the flat contact surface of the components, has a smaller diameter than a second section of the pin that is further away from the contact surface. The undercut improves the stability of the connection.

The positive pin connection preferably has an undercut of the pin on both sides. A pin with an undercut on both sides has an undercut along both lateral flanks of the slot. This is advantageous in order to prevent release of the pin connection even when force is applied on one side.

The positive pin connection can be designed, for example, as a dovetail connection or as a ball-and-socket connection. Both connections ensure a particularly secure connection of the components with simultaneous reversibility of the connection.

The positive pin connection can be attached at different positions of the base body and the cover plate. For example, the cover plate can protrude partially into the region between the two legs of the base body. This results in a planar contact surface between the cover plate and the inner side of the legs of the base body. On this planar contact surface, on one of the components the pin projects and engages in the slot of the other component.

In a preferred embodiment, the positive pin connection is attached to the end faces of the legs of the u-shaped base body. The pin connection in each case connects the end face of the first leg and the end face of the second leg to the polymeric cover plate. This is advantageous with regard to the stability of the connection when pressing the spacer with adjacent glass panes.

The pin of the positive pin connection can optionally be arranged on the polymeric cover plate or on the u-shaped profile, wherein the respective other component has the slot for receiving the pin. Embodiments in which a leg of the base body has a pin and a leg of the base body has a slot are also conceivable.

The pin and the slot of the positive pin connection are preferably realized running continuously along the entire spacer length. This has the advantage that the spacer can be cut as desired to the length sections required in the production of the insulating glass. Further, a secure connection is ensured over the entire length of the spacer.

The U-shaped polymeric base body can be designed in one piece or in multiple parts. A one-piece embodiment is advantageous with regard to a simple manufacture. In addition, in the case of a one-piece embodiment with a suitable material selection, a good sealing of the spacer against water vapor and oxygen can also be achieved without additional measures such as a barrier film.

In another preferred embodiment, the U-shaped polymeric base body is composed of several parts. In this way, a material optimized with respect to mechanical stability and from an economic and ecological point of view can be used in each region of the base body. Furthermore, a multi-part embodiment of the U-shaped polymeric base body can also be advantageous in order to remove further components attached on the spacer, such as a barrier film on the outer surface of the spacer. The U-shaped polymeric base body preferably comprises at least 2 parts, preferably 2 to 4 parts. In the case of a two-part U-shaped polymeric base body, this body comprises for example two polymeric side parts which are arranged on the legs of the base body and that abut and are connected to one another along the outer surface of the base body. The two polymeric side parts can also be connected indirectly via a barrier film attached to the outer surface. Alternatively or additionally, the polymeric side parts can also be connected, for example, at their contact surfaces via an adhesive and/or a positive connection.

The U-shaped polymeric base body preferably comprises at least one first polymeric side part as the first leg and a second polymeric side part arranged parallel thereto as a second leg. The first polymeric side part and the second polymeric side part are connected to one another via at least one polymeric connecting piece. The polymeric connecting piece extends in the transverse direction and forms the lower boundary of the base body. The polymeric connecting piece thus provides at least a part of the outer surface of the spacer.

The polymeric side parts are optionally connected to the polymeric connecting piece indirectly via a barrier film attached to the outer surface and/or directly via an adhesive attached to the respective contact surfaces and/or a positive connection.

The individual parts of the polymeric base body are preferably at least partially connected to one another via at least one positive pin connection. The positive pin connection can be designed analogously to the pin connection between the U-shaped polymeric base body and the cover plate. Preferably, this at least one positive pin connection is also provided with an undercut and is particularly preferably designed as a dovetail connection or ball-and-socket connection. In this way, the parts of the polymeric base body are simultaneously securely and reversibly connected to one another. The U-shaped polymeric base body preferably comprises a first polymeric side part, a second polymeric side part and a connecting piece, wherein the first polymeric side part and/or the second polymeric side part are each connected to the connecting piece via a positive pin connection.

After the end of the service life of the glazing, the spacer can be separated out and broken down into its individual components. For this purpose, for example first the cover plate is removed by separating the pin connection either with a tool that engages therein, or the cover plate is removed by sliding it along the slot. If the U-shaped polymeric base body is composed of several parts and is linked via pin connections, the polymeric side parts and the polymeric connecting piece can in principle be detached from one another in the same way. Alternatively or additionally, a pin connection within the polymeric base body can also be released by bending the base body open. For this purpose, the cover plate of the spacer is first removed and then the base body is bent outward, i.e., facing away from the hollow chamber of the spacer, at the polymeric side parts. The distance between the legs of the base body increases during this. Depending on the nature of the polymeric materials used and depending on the shape of the pin connection, the latter is released and/or breaks in the region of the pin. In both cases, separation of the spacer into its individual components and recycling of the individual polymer components is possible.

If the spacer comprises a barrier film on the outer surface of the U-shaped base body, a multi-part design of the base body facilitates its detachment. The U-shaped base body is bent open as described, causing any connection that may be present of the side parts and of the possibly present connecting piece to be released. At this point, the adhesive of the barrier film also detaches due to the resulting shear forces, so that starting from there the side parts can be bent further outwards and can be pulled off the barrier film. The barrier film is then removed from the connecting piece, if present. In this way, the spacer has good recycling properties even when a barrier film is used.

The U-shaped base body preferably comprises a gas-tight and vapor-tight barrier film which serves to improve the gas tightness of the base body. Preferably, this is applied at least on the outer surface of the polymeric U-shaped base body, preferably on the outer surface and on a part of the pane contact surfaces of the legs. The gas-tight and vapor-tight barrier improves the tightness of the spacer against gas loss and penetration of moisture. Preferably, the barrier is applied to approximately one-half to two-thirds of the pane contact surfaces, but can also be attached along larger regions or the entire height of the pane contact surfaces. A suitable barrier film is disclosed for example in WO 2013/104507 A1.

The barrier film preferably contains at least one polymeric layer and a metallic layer or a ceramic layer. The layer thickness of the polymeric layer is between 5 μm and 80 μm, while metallic layers and/or ceramic layers with a thickness of 10 nm to 200 nm are used. Within the mentioned layer thicknesses, a particularly good impermeability of the barrier film is achieved. The barrier film can be applied to the polymeric base body, for example glued.

Particularly preferably, the barrier film contains at least two metallic layers and/or ceramic layers which are arranged in alternating fashion with at least one polymeric layer. The layer thicknesses of the individual layers are preferably as described in the preceding paragraph. Preferably, here the outer layers are formed by a metallic layer. The alternating layers of the barrier film can be connected or applied to one another in a wide variety of methods known from the prior art. Methods for depositing metallic or ceramic layers are sufficiently known to the person skilled in the art. The use of a barrier film with an alternating layer sequence is particularly advantageous with regard to the tightness of the system. An error in one of the layers does not lead to a loss of function of the barrier film. In comparison, in the case of a single layer, even a small defect can cause a complete failure. Furthermore, the application of several thin layers is advantageous in comparison with a thick layer, since the risk of internal adhesion problems increases with increasing layer thickness. Furthermore, thicker layers have a higher conductivity so that such a film is thermodynamically less suitable.

The polymeric layer of the film preferably comprises polyethylene terephthalate, ethylene vinyl alcohol, polyvinylidene chloride, polyamides, polyethylene, polypropylene, silicones, acrylonitriles, polyacrylates, polymethyl acrylates and/or copolymers or mixtures thereof. The metallic layer preferably contains iron, aluminum, silver, copper, gold, chromium and/or alloys or oxides thereof. The ceramic layer of the film preferably contains silicon oxides and/or silicon nitrides.

In a particularly preferred embodiment, the gas-tight and vapor-tight barrier has at least one metallic layer or ceramic layer which is designed as a coating and contains aluminum, aluminum oxides and/or silicon oxides and is preferably applied via a PVD process (physical vapor deposition).

The U-shaped polymeric base body and/or the polymeric cover can contain additional elements that improve the stability of the spacer. These can be attached to the surfaces of the base body and/or the polymeric cover facing the hollow chamber of the spacer, to the outer surface and/or to the glazing interior surface of the spacer. Furthermore, these can also be hollow structures within the U-shaped polymeric base body and/or the cover plate which lie between the surface facing the hollow chamber and the surface of the spacer facing the surrounding environment. Depending on the embodiment, the additional stability-improving elements can be raised or set back with respect to the surfaces of the base body or the cover plate.

The U-shaped polymeric base body preferably comprises a hollow structure at least in sections. The hollow structure reduces the weight of the U-shaped polymeric base body. Furthermore, the hollow structure advantageously contains reinforcing elements protruding into the hollow space of the hollow structure, which improve the stability of the base body. The base body preferably comprises a honeycomb-like hollow structure. This is particularly advantageous with regard to its stability. In particular, the U-shaped polymeric base body comprises two polymeric side parts and a connecting piece, wherein the connecting piece carries the honeycomb-like hollow structure. In this way, the connecting piece with hollow structure can be made of a different material than the side parts.

The polymeric covering and/or the U-shaped polymeric base body preferably comprise reinforcing elements. These reinforcing elements are formed as raised parts which extend along the spacer in the longitudinal direction and increase the rigidity thereof. In particular, a reinforcing element extending in a strip shape along the longitudinal direction of the spacer is attached to the surface of the cover plate facing the hollow chamber of the spacer. This prevents bending of the spacer and thus facilitates its handling in the production process.

The spacer according to the invention can be connected to a spacer frame for producing an insulating glazing via corner connectors which are inserted into the hollow chamber of the spacer. Furthermore, the spacer profiles can also be provided with a miter cut and welded together in the corner region. In both embodiments, an open cross-section of the spacer is present in the corner regions of the insulating glazing, which cross-section is to be sealed by welding the materials and/or sealing remaining gaps. These corner regions represent a possible weak point of the insulating glazing. A solution to this problem consists in bending the spacers in the corner region. In order to improve the bendability of the spacer according to the invention, it preferably has at least one indentation on the first pane contact surface of the first leg and/or on the second pane contact surface of the second leg. Preferably, both pane contact surfaces each have at least one indentation which extends continuously along the spacer in the longitudinal direction and improves its bendability.

The polymeric cover plate is preferably gas-permeable at least in sections. Here the polymeric cover plate can be produced from a plastic which is open to vapor diffusion. Alternatively and/or additionally, the polymeric cover plate can have openings. A gas-permeable cover plate allows a gas exchange between the glazing interior and the hollow chamber of the spacer. In the region of any openings there is a direct passage between the hollow chamber and the region above the glazing interior surface. In the installed state of the spacer in an insulating glazing, the openings connect the interior of the hollow chamber to the glazing interior, thereby enabling a gas exchange between them. As a result, an absorption of air moisture by a desiccant located in the hollow chamber is permitted, thereby preventing fogging of the panes. The openings are preferably designed as slots, particularly preferably as slots with a width of 0.1 mm to 0.3 mm, for example 0.2 mm, and a length of 1.5 mm to 3.5 mm, for example 2 mm. The slots ensure optimal exchange of air without desiccant from the hollow chamber being able to penetrate into the inner pane intermediate space. The total number of openings here is a function of the size of the insulating glazing.

The polymeric covering and the one-piece or multi-part polymer U-shaped base body can be manufactured from the same or different materials. Even if all polymeric components of the spacer are made of the same material, the spacer according to the invention offers improved recyclability. The cover plate is easily separable from the polymeric base body, so that desiccant located in the hollow chamber can be removed with little effort. If the cover plate and the one-piece or multi-part base body comprise different polymeric materials, the components can initially be extruded individually and subsequently connected. Alternatively, components can also be produced together by coextrusion or by extruding a further component onto an already-existing component. In the case of coextrusion of two components, both polymers are in the flowable state; when a second component is extruded onto a provided first component, this is the case at least for the second component. As a result, there is a good adhesion of the components to one another at the contact surface of the components. In such a case, for example, an undercut of the pin connection can be dispensed with. In the case of coextruded or components extruded onto one another, pin connections can preferably be separated by means of a tool inserted at the cross-section of the spacer, said tool being guided along the contact surface between the pin and the slot for this purpose.

The polymeric covering and/or the U-shaped polymeric base body preferably comprise polyethylene (PE), polypropylene (PP), styrene-acrylonitrile (SAN), polyamides, polyethylene terephthalate (PET), polybutylene terephthalate (PBT), acrylonitrile butadiene styrene (ABS), acrylic ester styrene-acrylonitrile (ASA), ethylene vinyl alcohol (EVOH), polylactides (PLA), cellulose acetate (CA), polyhydroxyalkanoates (PHA), polyhydroxybutyric acid (PHB), polyhydroxyvaleric acid (PHV), polyethylene furanoate (PEF), polybutylene adipate terephthalate (PBAT), polybutylene succinate (PBS) and/or copolymers and/or mixtures thereof.

The spacer according to the invention can thus comprise conventional non-biodegradable plastic materials from fossil raw materials, biodegradable plastics from fossil raw materials, non-biodegradable plastics based on renewable raw materials, biodegradable plastics based on renewable raw materials and/or can be manufactured from recycled plastics. The materials of the U-shaped base body and the cover plate can also be selected from various of these groups thanks to the good separability of the components. This also applies to the side parts, the connecting piece, and optionally further components of a multipart polymeric base body. Among the conventional plastics, polyethylene (PE), polypropylene (PP), styrene-acrylonitrile (SAN), polyamides, polyethylene terephthalate (PET), polybutylene terephthalate (PBT), acrylonitrile butadiene styrene (ABS), acrylic ester styrene-acrylonitrile (ASA) and ethylene-vinyl alcohol (EVOH) have proven to be particularly suitable for forming the U-shaped polymeric base body and/or the cover plate. In particular, these conventional plastics are preferably used in the form of recycled material. At least polyethylene (PE), polypropylene (PP) and polyethylene terephthalate (PET) are also already producible from renewable non-fossil raw materials; the group of polymers producible from renewable raw materials is growing constantly, accompanied by the increased research interest in this field.

Particularly preferably, the U-shaped polymeric main body, individual components of the U-shaped polymeric base body and/or the cover plate are manufactured from a biodegradable plastic based on renewable raw materials. Preferably used here are polylactides (PLA), cellulose acetate (CA), polyhydroxyalkanoates (PHA), polyhydroxybutyric acid (PHB), polyhydroxyvaleric acid (PHV), polyethylene furanoate (PEF), polybutylene adipate terephthalate (PBAT), polybutylene succinate (PBS) and/or copolymers or mixtures thereof. Polyhydroxyalkanoates (PHA), polyhydroxybutyric acid (PHB) and/or polyhydroxyvaleric acid (PHV) can, for example, substitute the polypropylene frequently used in spacers, while polybutylene adipate terephthalate (PBAT) and/or polybutylene succinate (PBS) have similar properties to low density polyethylene (LDPE). Polylactides (PLA) and/or polyethylene furanoate (PEF) can be used in the areas of application of PET, here polyethylene furanoate (PEF) has an advantageously reduced oxygen permeability compared to PET. Polylactides (PLA) have high UV resistance, which is advantageous for example for manufacturing the cover plate. The temperature resistance of polylactides can be increased, for example, by adding reinforcing fibers such that the requirements are also met in this regard.

The polymeric covering and the U-shaped polymeric base body preferably comprise different materials. This is advantageous in order, for example, to be able to use a plastic of high optical quality for the cover plate, visible in the installed state of the insulating glazing, while plastics having a lower optical quality can also be used for the non-visible components of the U-shaped polymeric base body. Such a lower optical quality is present, for example, in recycled plastics, which can be obtained for example from recycled spacers. In this way, spacers according to the invention can be returned to the production process after the end of their service life. The polymeric covering and the U-shaped polymeric base body preferably comprise different materials, the melting points of which differ. The melting points of the material of the polymeric covering and of the material of the U-shaped polymeric base body preferably differ by at least 5° C., preferably by at least 10° C., in particular by at least 20° C. If the U-shaped polymeric base body consists of multiple components, then the melting points of the different components differ preferably both from one another and from the melting point of the material of the polymeric cover plate, particularly preferably in each case by at least 5° C., preferably by at least 10° C., in particular by at least 20° C. in each case. The different melting points of the polymeric materials enable the spacer to be separated into its individual polymeric components by melting or thermal softening. To melt the spacer, the temperature is increased stepwise up to the melting temperature of the material with the lowest melting point, so that at least one component of the U-shaped polymeric base body or the cover plate melts. The polymer melt is then separated off and the temperature is increased up to the melting point of the remaining component having the lowest melting point. The melted component is then removed again and the process is continued until all components of the spacer are melted. In particular in the case of coextruded or extruded components of the U-shaped polymeric base body and/or the cover plate, this procedure can be advantageous in order to ensure a simplified separation. As an alternative to a complete melting of the polymeric components of the spacer, it is also conceivable to first heat the spacer just to the point at which a component of the spacer begins to soften. The polymer component softened by the supply of heat can then be easily removed with mechanical means. This process is repeated until all components are separated by type. In comparison with complete melting, this procedure is more energy-efficient. It is also possible to first remove the cover plate with mechanical means, for example by moving the base body and the cover plate along the slot of the pin connection, and then to separate a multipart U-shaped polymeric base body into its polymeric components by step-by-step melting or thermal softening.

In a particularly preferred embodiment, the cover or the U-shaped polymeric base body comprises polyethylene terephthalate (PET), polyethylene furanoate (PEF) and/or polylactides (PLA) and/or mixtures or copolymers thereof, wherein the U-shaped polymeric base body belonging to the cover or the cover belonging to the base body comprises acrylonitrile-butadiene-styrene (ABS), acrylic ester-styrene-acrylonitrile (ASA) and/or styrene-acrylonitrile (SAN) and/or mixtures or copolymers thereof.

In one possible embodiment, the outer surface of the U-shaped polymeric base body runs flat and parallel to the cover plate. In a further possible embodiment, the outer surface of the U-shaped polymeric base body is each angled adjacent to the pane contact surfaces, thereby achieving increased stability of the base body. Adjacent to the first pane contact surface, the outer surface has a first angled section and, adjacent to the second pane contact surface, a second angled section. The first angled section assumes an angle α of 120° to 150° to the adjacent first pane contact surface, while the second angled section assumes an angle α of 120° to 150° to the adjacent second pane contact surface.

In a preferred embodiment of the invention, the first angled section and the second angled section each have an angle α of 130° to 140° to the respectively adjacent pane contact surface. This is advantageous for further improving the mechanical stability of the spacer. Preferably, the angle α between the first angled section and the pane contact surface assumes the same value as the angle α between the second angled section and the pane contact surface. Such a symmetrical design leads to further stability advantages.

The height of the spacer is determined as the maximum height of the spacer between the glazing interior surface and the outer surface. The height of the spacer is preferably 5.0 mm to 10.0 mm, particularly preferably 6.0 mm to 8.0 mm, in particular 6.5 mm to 7.0 mm. Within these ranges, good stability of the spacer and secure bonding of the panes to the pane contact surfaces is achieved.

The width of the spacer is defined as the maximum extension of the spacer between the opposite pane contact surfaces. The width of the spacer depends substantially on the desired pane intermediate spaces of the insulating glazing to be produced. The width of the spacer is typically 4 mm to 30 mm, preferably 8 mm to 16 mm.

The wall thickness of the base body is preferably between 0.5 mm and 1.5 mm, particularly preferably between 0.8 mm and 1.2 mm. Good stability is achieved in these ranges. At the same time, the material consumption is kept as low as possible.

Preferably, reinforcing fibers are incorporated into the cover plate and/or the one-piece or multi-part base body. A wide variety of reinforcing agents in polymeric base bodies are known to those skilled in the art, in the form of fibers, powders or platelets. Powder and/or platelet reinforcing agents include, for example, mica and talc. Particularly preferred with regard to mechanical properties are reinforcing fibers, which include glass fibers, aramid fibers, carbon fibers, ceramic fibers, or natural fibers are to be added. Alternatives to this are also ground glass fibers or hollow glass spheres. These hollow glass spheres have a diameter of 10 μm to 20 μm and improve the stability of the polymeric hollow profile. Suitable hollow glass spheres are commercially available under the name “3M™ Glass Bubbles.” In one possible embodiment, the polymeric base body contains both glass fibers and hollow glass spheres. An admixture of hollow glass spheres leads to a further improvement in the thermal properties of the hollow profile.

Particularly preferably, glass fibers are used as reinforcing agents, these being added in a proportion of 25% to 50% by weight, in particular in a proportion of 30% to 40% by weight. Within these ranges, good mechanical stability and strength of the base body can be observed. Furthermore, a glass fiber content of 30% by weight to 40% by weight is readily compatible with the multilayer barrier film made of alternating polymeric layers and metallic layers applied to the outer surface of the spacer in a preferred embodiment. By adapting the coefficient of thermal expansion of the polymeric base body and of the barrier film or coating, temperature-induced stresses between the different materials and flaking of the barrier film or coating can be avoided.

The invention further comprises an insulating glazing with spacer according to the invention. The insulating glazing contains at least a first pane, a second pane, and a peripheral spacer according to the invention that surrounds the panes.

The glazing interior of the insulating glazing is located adjacent to the glazing interior surface of the spacer. In contrast, the outer surface of the spacer is adjacent to the outer pane intermediate space. The first pane is here attached to the first pane contact surface of the spacer and the second pane is attached to the second pane contact surface of the spacer.

The first and the second pane are attached to the pane contact surfaces preferably via a sealant which is attached between the first pane contact surface and the first pane and/or the second pane contact surface and the second pane.

The sealant preferably contains butyl rubber, polyisobutylene, polyethylene vinyl alcohol, ethylene vinyl acetate, polyolefin rubber, polypropylene, polyethylene, copolymers and/or mixtures thereof.

The sealant is preferably introduced into the gap between spacer and panes in a thickness of 0.1 mm to 0.8 mm, particularly preferably 0.2 mm to 0.4 mm.

The outer pane intermediate space of the insulating glazing is preferably filled with an outer seal. This outer seal serves primarily to adhesively bond the two panes, thus promoting the mechanical stability of the insulating glazing.

The outer seal preferably contains polysulfides, silicones, silicone rubber, polyurethanes, polyacrylates, copolymers and/or mixtures thereof. Such materials have very good adhesion to glass, so that the outer seal ensures a secure bonding of the panes. The thickness of the outer seal is preferably 2 mm to 30 mm, particularly preferably 5 mm to 10 mm.

In a particularly preferred embodiment of the invention, the insulating glazing comprises at least three panes, wherein a further spacer frame is attached to the first pane and/or the second pane, to which frame the at least third pane is fastened. The first and the second pane and optionally the third pane abut the pane contact surfaces of the respectively adjacent spacer.

The first pane, the second pane and/or the third pane of the insulating glazing preferably contain glass, particularly preferably quartz glass, borosilicate glass, soda lime glass and/or mixtures thereof. The first and/or second pane of the insulating glazing can also comprise thermoplastic polymeric panes. Thermoplastic polymeric panes preferably comprise polycarbonate, polymethyl methacrylate and/or copolymers and/or mixtures thereof. Additional panes of insulating glazing can have the same composition as mentioned for the first, second and third pane.

The first pane and the second pane have a thickness of 2 mm to 50 mm, preferably 2 mm to 10 mm, particularly preferably 4 mm to 6 mm, wherein both panes can also have different thicknesses.

The first pane, the second pane and further panes can be made of single-pane safety glass, of thermally or chemically tempered glass, of float glass, of extra-clear low-iron float glass, colored glass, or of laminated safety glass containing one or more of these components. The panes can have any further components or coatings, for example low-E layers or other sun protection coatings.

The outer pane intermediate space, delimited by the first pane, second pane, and outer surface of the spacer, is at least partially, preferably completely, filled with an outer seal. This achieves very good mechanical stabilization of the edge assembly.

The outer seal preferably contains polymers or silane-modified polymers, particularly preferably organic polysulfides, silicones, room-temperature crosslinking (RTV) silicone rubber, peroxide-crosslinked silicone rubber and/or addition-crosslinked silicone rubber, polyurethanes and/or butyl rubber.

The sealant between the first pane contact surface and the first pane, or between the second pane contact surface and the second pane, preferably contains a polyisobutylene. The polyisobutylene may be a crosslinking or non-crosslinking polyisobutylene.

The insulating glazing is optionally filled with a protective gas, preferably with a noble gas, preferably argon or krypton, which reduce the heat transfer value in the insulating glazing intermediate space.

In principle, a wide variety of geometries of the insulating glazing are possible, for example rectangular, trapezoidal and rounded shapes. To produce round geometries, the spacer can be bent, for example in the heated state.

At the corners of the insulating glazing, the spacers are linked to one another, for example via corner connectors. Such corner connectors can be designed, for example, as a plastic molded part with a seal in which two spacers abut.

Alternatively, the spacers can also be connected directly to one another at the corners, for example by welding the spacers adjoining one another in the corner region. For example, the spacers are cut to 45° miter and connected to one another by ultrasonic welding.

In a particularly preferred embodiment, the spacer is not separated at the corners of the glazing and connected at the required angle via corner connectors, but rather is bent into the corresponding corner geometry with heating.

A preferred method for producing a spacer according to the invention comprises at least the steps:
a) providing a polymer mixture for producing a U-shaped polymeric base body,
b) melting the polymer mixture in an extruder,
c) exit of the melt from the extruder through a molding tool and molding a base body,
c) stabilizing the base body and
d) cooling the base body.

During or after these steps, a cover plate is applied to the base body, yielding the spacer.

The polymeric components of the mixture in step a) are preferably provided in the form of granules. As a result, these are easily dosed and easy to handle. Preferably, a reinforcing agent is added to the polymer mixture in step a). The reinforcing agent is in the form of a fiber or is spherical, and is thus likewise easy to dose.

The mixture provided in step a) preferably comprises color pigments and/or additives, particularly preferably at least color pigments. The color pigments are provided in the form of a polymer-bound color pigment in which the color pigment is pressed with the thermoplastic base material used for the spacer, in the form of granules. These granules, also known colloquially as color masterbatch, improve the dosability of the color pigments and increase the technical process reliability in the processing. A polymer-bound color pigment is optionally added to the mixture in step a) in an amount of 1.0 wt % to 4.0 wt %, depending on the desired coloration.

If the U-shaped polymeric base body is to be realized in several parts, the individual components are preferably each produced according to steps a) to d) and then connected, for example by a pin connection of the components to one another. Alternatively, the components of a multipart base body can be coextruded or extruded onto one another, analogously to steps a) to d).

The cover plate can be produced according to a method comprising steps a) to d) and then applied to the base body via the pin connection according to the invention. Alternatively, the cover plate can be coextruded with the base body or extruded onto it. If a desiccant is provided in the hollow chamber of the spacer, it can either be introduced into the base body before the cover plate is applied, or can be filled after application of the cover plate, via the open cross-section of the spacer.

In a preferred embodiment, a gas-tight and vapor-tight barrier film is attached to the outer side of the base body. Preferably, this is glued to the base body.

The spacer produced by means of one of the described methods can be used in a method for producing an insulating glazing. Such a method comprises at least the steps:
e) providing spacers according to the invention,
f) assembling a spacer frame from spacers according to the invention,
g) attaching a first pane to the first pane contact surface of the spacer frame via a sealant, attaching a second pane to the second pane contact surface of the spacer frame via a sealant,
h) optionally: attaching at least one further spacer frame to the first pane and/or the second pane and attaching a third, and optionally, further panes to the further spacer frame,
i) pressing the pane assembly,
j) introducing an outer seal into the outer pane intermediate space.

The adhesive bonding of the panes to the pane contact surfaces according to step g) can be carried out in any order. Optionally, the bonding of both panes to the pane contact surfaces can also take place simultaneously.

In step j), the outer pane intermediate space is filled at least partially, preferably completely, with an outer seal. The outer seal is preferably extruded directly into the outer pane intermediate space, for example in the form of a plastic sealing compound.

Preferably, the glazing interior between the panes is filled with a protective gas before the assembly (step i) is pressed.

The features disclosed with respect to a method for producing the spacer according to the invention and a method for producing the insulating glazing according to the invention also apply to the spacer according to the invention and the insulating glazing according to the invention.

In the following, the invention is explained in more detail with the aid of drawings. The drawings are purely schematic and are not to scale. The drawings do not limit the invention in any way. In the drawings:

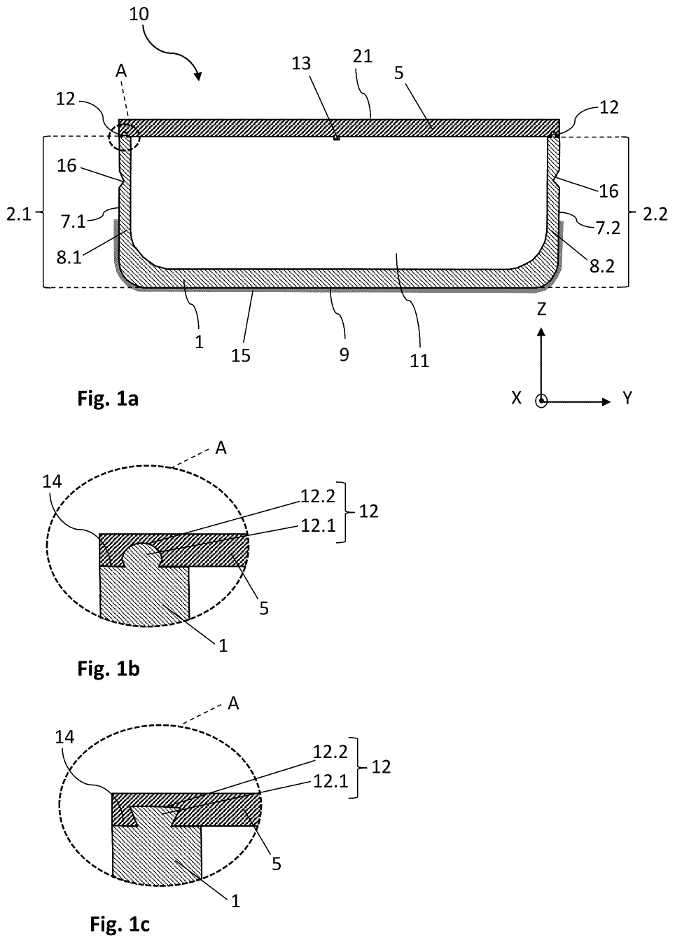

FIG. 1a shows a schematic representation of a spacer according to the invention in cross-section,

FIG. 1b shows a possible embodiment of the pin connection of the spacer according to FIG. 1a shown in detail A,

FIG. 1c shows a further possible embodiment of the pin connection of the spacer according to FIG. 1a shown in detail A,

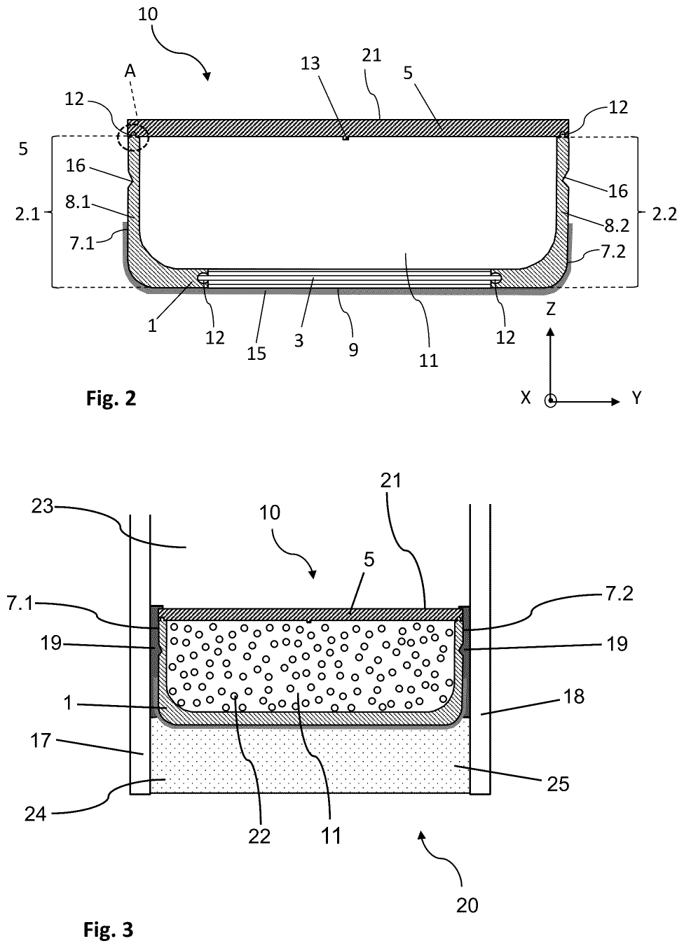

FIG. 2 shows a schematic cross-sectional view of a further spacer according to the invention with a multi-part U-shaped polymeric base body,

FIG. 3 shows a schematic representation of an insulating glazing with spacer according to the invention in cross-section.

FIG. 1 shows a schematic illustration of the spacer 10 according to the invention comprising a U-shaped polymeric base body 1 and a cover plate 5, which are connected to one another via a pin connection 12. The U-shaped polymeric base body 1 has a first leg 2.1 and a second leg 2.2, which are connected to one another via an outer surface 9 and in this way form the U-shape of the base body 1. The U-shaped polymeric base body 1 comprises a first pane contact surface 7.1 and a second pane contact surface 7.2, on which the panes can be attached in an insulating glazing in the installed state. A water-tight and vapor-tight barrier film 15, which reduces the gas transport through the polymeric base body 1 into the glazing interior of an insulating glazing unit, is applied to the outer surface 9 and optionally to partial regions of the pane contact surfaces 7.1, 7.2 of the spacer 1. The barrier film 15 has three polymeric layers of polyethylene terephthalate with a thickness of 12 μm and three metallic layers of aluminum with a thickness of 50 nm. The metallic layers and the polymeric layers are each here attached in alternating fashion, wherein the layer of barrier film 15 facing the outer pane intermediate space of the insulating glazing in the installed state of the spacer is a metallic layer. The barrier film 15 is glued to the base body 1. In the installed state, the cover plate 5 faces the glazing interior in an insulating glazing. The surface of the cover plate 5 facing the glazing interior thus represents the glazing interior surface 21 of the spacer 10. The cover plate 5 is connected via the pin connection 12 to the legs 2.1, 2.2 of the base body 1 in such a way that the base body 1 and the cover plate 5 enclose a hollow chamber 11 which is suitable for being filled with a desiccant. The glazing interior surface 21 of the spacer 10 has openings (not shown) which are attached at regular intervals to enable a gas exchange between the interior of the insulating glazing and the hollow chamber 11. Thus, any air humidity present in the interior space is absorbed by the desiccant. On the surface of the cover plate facing the hollow chamber 11, a reinforcing element 13 is attached in the form of a strip running through in the longitudinal direction X, which reduces bending of the spacer 10. An indentation 16, which facilitates bending of the spacer 10 in the corner regions of the insulating glazing unit, is located on each of the pane contact surfaces 7.1, 7.2 of the base body 1.

FIGS. 1b and 1c each show a possible embodiment of the pin connection 12 of the spacer 10 according to FIG. 1a, respectively shown in detail A. The pin connection 12 comprises a pin 12.1 on the end face 14 of the legs 2.1, 2.2 of the base body 1, which is inserted into a slot 12.2 of the cover plate 5. The pin connection 12 has an undercut, by which a stable connection of the base body 1 and the cover plate 5 is ensured. The pin 12.1 of the pin connection 12 can have rounded geometries (see FIG. 1b) or can also be designed with an angular cross-section (see FIG. 1c).

FIG. 2 shows a further embodiment of a spacer 1 according to the invention with a multi-part U-shaped polymer base body 1. The embodiment substantially corresponds to that described in FIG. 1a, wherein, in contrast thereto, the U-shaped polymeric base body 1 comprises multiple components. The first leg 2.1 is here formed by a first polymeric side part 8.1 and the second polymeric leg is formed by a second polymeric side part 8.2. The polymeric side parts 8.1, 8.2 are linked to one another via a polymeric connecting piece 3. The polymeric connecting piece 3 here forms the outer surface 9 of the base body 1. The cover plate 5 and the base body 1 are linked to one another via pin connections 12 according to FIG. 1b and/or FIG. 1c. The connection between the first polymeric side part 8.1 and the polymeric connecting piece 3 and between the first polymeric side part 8.2 and the polymeric connecting piece 3 takes place in the same way.

FIG. 3 shows an insulating glazing 20 with the spacer 10 according to the invention according to FIG. 1a, in cross-section. The spacer 10 according to the invention is attached peripherally between a first pane 17 and a second pane 18 via a sealant 19. The sealant 19 here connects the pane contact surfaces 7.1 and 7.2 of the spacer 10 to the panes 17, 18. The hollow chamber 11 is filled with a desiccant 22. Molecular sieve is used as the desiccant 22. The glazing interior 23 adjoining the glazing interior surface 21 of the spacer 1 is defined as the space delimited by the panes 17, 18 and the spacer 10. The outer pane intermediate space 24 adjoining the outer surface 9 of the spacer 10 is a strip-shaped peripheral section of the glazing, which is delimited by one side of each of the two panes 17, 18 and on a further side by the spacer 10, and whose fourth edge is open. The glazing interior 23 is filled with argon. A sealant 19, which seals the gap between pane 17, 18 and spacer 10, is introduced between each pane contact surface 7.1 or 7.2 and the adjacent pane 17 or 18. The sealant 19 is polyisobutylene. An outer seal 25, which serves to bond the first pane 17 and the second pane 18, is attached to the outer surface 9 in the outer pane intermediate space 24. The outer seal 25 is made of polysulfide. The outer seal 25 terminates flush with the pane edges of the first pane 17 and the second pane 18.

### LIST OF REFERENCE SIGNS

10 Spacer
20 Insulating glazing
1 U-shaped polymeric base body
2 Legs of the U-shaped polymeric base body
2.1 First leg
2.2 Second leg
3 Polymeric connecting piece
5 Polymeric cover plate
7 Pane contact surfaces
7.1 First pane contact surface
7.2 Second pane contact surface
8 Polymeric side parts
8.1 First polymeric side part
8.2 Second polymeric side part
9 Outer surface
11 Hollow chamber
12 Positive pin connection
12.1 Pin of the positive pin connection
12.2 Slot of the positive pin connection
13 Reinforcing elements
14 End faces of the legs 2
15 Barrier film
16 Indentation
17 First pane
18 Second pane
19 Sealant
21 Glazing interior surface
22 Desiccant
23 Glazing interior
24 Outer pane intermediate space
25 Outer seal
X Longitudinal direction
Y Transverse direction

1. A spacer for insulating glazings, comprising:
a U-shaped polymeric base body extending in a longitudinal direction, comprising a first leg having a first pane contact surface, a second leg having a second pane contact surface and an outer surface, via which the first pane contact surface and the second pane contact surface are connected to one another,
a polymeric cover plate extending in a transverse direction parallel to the outer surface between the first pane contact surface and the second pane contact surface, and comprising a glazing interior surface,
wherein
the polymeric cover plate encloses a hollow chamber with the U-shaped polymeric base body,
the polymeric cover plate is connected to the first leg and the second leg of the U-shaped polymeric base body in each case via at least one positive pin connection.

2. The spacer according to claim 1, wherein the at least one positive pin connection has an undercut.

3. The spacer according to claim 2, wherein the at least one positive pin connection is designed as a dovetail connection or as a ball-and-socket connection.

4. The spacer according to claim 1, wherein the at least one positive pin connection in each case connects an end face of the first leg and an end face of the second leg to the polymeric cover plate.

5. The spacer according to claim 1, wherein the U-shaped polymeric base body comprises a first polymeric side part as first leg, a second polymeric side part arranged parallel thereto as second leg, and a polymeric connecting piece extending in the transverse direction which connects the first and second polymeric side parts, and the polymeric connecting piece forms a lower boundary of the base body.

6. The spacer according to claim 5, wherein the first polymeric side part and/or the second polymeric side part are connected to the polymeric connecting piece via a positive pin connection.

7. The spacer according to claim 1, wherein the U-shaped polymeric base body comprises a barrier film at least on the outer surface.

8. The spacer according to claim 1, wherein the U-shaped polymeric base body comprises a hollow structure at least in sections.

9. The spacer according to claim 1, wherein the polymeric cover plate and/or the U-shaped polymeric base body comprise reinforcement elements.

10. The spacer according to claim 1, wherein the first leg has at least one indentation on the first pane contact surface and/or the second leg has at least one indentation on the second pane contact surface.

11. The spacer according to claim 1, wherein the polymeric cover plate is open to vapor diffusion at least in sections.

12. The spacer according to claim 1, wherein the polymeric cover plate and/or the U-shaped polymeric base body comprise polyethylene (PE), polypropylene (PP), styrene-acrylonitrile (SAN), polyamides, polyethylene terephthalate (PET), polybutylene terephthalate (PBT), acrylonitrile butadiene styrene (ABS), acrylic ester styrene-acrylonitrile (ASA), ethylene vinyl alcohol (EVOH), polylactides (PLA), cellulose acetate (CA), polyhydroxyalkanoates (PHA), polyhydroxybutyric acid (PHB), polyhydroxyvaleric acid (PHV), polyethylene furanoate (PEF), polybutylene adipate terephthalate (PBAT), polybutylene succinate (PBS), and/or copolymers and/or mixtures thereof.

13. The spacer according to claim 1, wherein the polymeric cover plate and the U-shaped polymeric base body comprise different materials.

14. The spacer according to claim 1, wherein the polymeric cover plate comprises polyethylene terephthalate (PET), polyethylene furanoate (PEF) and/or polylactides (PLA) and/or mixtures or copolymers thereof, and the U-shaped polymeric base body comprises acrylonitrile butadiene styrene (ABS), acrylic ester styrene-acrylonitrile (ASA) and/or styrene-acrylonitrile (SAN) and/or mixtures or copolymers thereof, or the U-shaped polymeric base body comprises polyethylene terephthalate (PET), polyethylene furanoate (PEF) and/or polylactides (PLA) and/or mixtures or copolymers thereof, and the polymeric cover plate comprises acrylonitrile butadiene styrene (ABS), acrylic ester styrene-acrylonitrile (ASA) and/or styrene-acrylonitrile (SAN), and/or mixtures or copolymers thereof.

15. An insulating glazing comprising a spacer according to claim 1, a first pane and a second pane, the first pane being attached to the first pane contact surface of the spacer via a sealant, and the second pane being attached to the second pane contact surface of the spacer via a sealant.

16. The spacer according to claim 6, wherein the first polymeric side part and/or the second polymeric side part are connected to the polymeric connecting piece via a positive pin connection with an undercut.

17. The spacer according to claim 6, wherein the first polymeric side part and/or the second polymeric side part are connected to the polymeric connecting piece via a dovetail connection or ball-and-socket connection.

18. The spacer according to claim 8, wherein the hollow structure is a honeycomb-like hollow structure.

19. The spacer according to claim 13, wherein a melting point of the material of the polymeric cover plate and a melting point of the material of the U-shaped polymeric base body differ.

20. The spacer according to claim 19, wherein the melting point of the material of the polymeric cover plate and the melting point of the material of the U-shaped polymeric base body differ by at least 5° C.
